(19) United States
(12) Patent Application Publication
(10) Pub. No.: US 2019/0122694 A1
(43) Pub. Date: Apr. 25, 2019

(54) HEAD GIMBAL ASSEMBLY SOLDER JOINTS AND FORMATION THEREOF USING BOND PAD SOLDER DAMS

(71) Applicant: Seagate Technology LLC, Cupertino, CA (US)

(72) Inventors: Paul Davidson, Eden Prairie, MN (US); Scott Damon Matzke, Shakopee, MN (US); Aaron Michael Collins, Minneapolis, MN (US)

(21) Appl. No.: 15/788,886

(22) Filed: Oct. 20, 2017

(51) Int. Cl. G11B 5/48; G11B 5/31

(52) U.S. Cl. CPC G11B 5/4826; G11B 5/3109

(57) ABSTRACT

A magnetic recording head including a trailing surface and a plurality of bond pads in a row, each of which is spaced by a gap from an adjacent bond pad along a width of the trailing surface. Each bond pad includes two side edges spaced from each other across a width of the bond pad, wherein a width of the gap between adjacent bond pads is defined by one side edge of each of two adjacent bond pads, and a top edge extending between the two side edges. The head further includes at least one solder dam including a nonwettable, electrically conductive solder material positioned adjacent to the top edge of at least one of the bond pads.

### BACKGROUND

Hard disc drive (HDD) systems typically include one or more data storage discs with concentric tracks containing information. A transducing head carried by a slider is used to read from and write to a data track on a disc, wherein each slider has an air bearing surface that is supportable by a cushion of air generated by one of the rotating discs. The slider is carried by an arm assembly that includes an actuator arm and a suspension assembly, which can include a separate gimbal structure or can integrally form a gimbal.

As the density of data desired to be stored on discs continues to increase, more precise positioning of the transducing head and other components is becoming increasingly important. In many conventional systems, head positioning is accomplished by operating the actuator arm with a large scale actuation motor, such as a voice coil motor, to position a head on a flexure at the end of the actuator arm. A high resolution head positioning mechanism, or microactuator, is advantageous to accommodate the high data density.

The precision manufacturing of components of disk drive systems includes providing an electrical connection via solder material between sliders and suspension assemblies, either or both of which may include bonding pads. In particular, a trailing surface of a magnetic recording head can have a number of bonding pads that correspond to the same number of electrical pads that are positioned on a suspension tongue, wherein the electrical pads are connected to electrical traces. The electrical connection is provided by placing solder joints between the bonding pads and the electrical pads, which thereby electrically connects the magnetic recording head to the electrical traces.

The solder material used for electrical connection of components is often supplied via solder jetting, wherein typical trailing slider surface interconnects are provided in a single plane and arranged in a single row. Such a configuration, in combination with at least some inherent trajectory error and possible solder ball expansion upon impact with a surface to which it is applied, can lead to inadequate separation between the solder interconnect and adjacent interconnects, bonding pads, or traces. This can then lead to bridged or open connections in high connection density applications. These challenges will increase as the number of slider pads provided on a slider is increased. There is therefore a desire to provide slider configurations that allow for accurate placement of the solder connections in high density applications, along with improved control of the size and shape of the solder joints.

### SUMMARY

Aspects of the invention described herein are directed to the placement of solder materials to provide for consistent connection of sliders to their associated head gimbal assemblies in hard disc drives. Such methods and configurations are particularly beneficial with the continuing desire to decrease the size of electronic components in the data storage industry.

In accordance with an aspect of the invention, a magnetic recording head is provided that comprises a trailing surface, a plurality of bond pads in a row, each of which is spaced by a gap from an adjacent bond pad along a width of the trailing surface. Each bond pad includes two side edges spaced from each other across a width of the bond pad, wherein a width of the gap between adjacent bond pads is defined by one side edge of each of two adjacent bond pads, and a top edge extending between the two side edges. The head further includes at least one solder dam comprising nonwettable, electrically conductive solder material positioned adjacent to the top edge of at least one of the bond pads.

In accordance with another aspect of the invention, a head gimbal assembly is provided that includes a suspension comprising multiple electrical pads and a magnetic recording head. The magnetic recording head comprises a trailing surface, a plurality of bond pads in a row, each of which is spaced by a gap from an adjacent bond pad along a width of the trailing surface. Each bond pad includes two side edges spaced from each other across a width of the bond pad, wherein a width of the gap between adjacent bond pads is defined by one side edge of each of two adjacent bond pads, and a top edge extending between the two side edges. The head further includes at least one solder dam comprising nonwettable, electrically conductive solder material positioned adjacent to the top edge of at least one of the bond pads. The assembly further includes at least one solder joint having a top edge adjacent to the at least one solder dam, wherein each solder joint electrically connects one of the bond pads to one of the electrical pads of the suspension.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of a magnetic recording head in accordance with the invention;

FIG. 2 is an enlarged perspective view of a portion of the trailing edge of the magnetic recording head of FIG. 1;

FIG. 3 is a perspective view of the magnetic recording head of FIG. 1 mounted to a suspension tongue, including an exemplary solder joint electrically connecting a bond pad of the head to an electrical pad of the suspension;

FIG. 4 is an enlarged perspective view of a portion of the trailing edge of the magnetic recording head and suspension tongue of FIG. 3, including an exemplary solder joint;

FIG. 5 is a schematic side view of exemplary layers on a magnetic recording head electrically connected to a suspension with a solder joint and including a solder dam;

FIG. 6 is another schematic view of exemplary layers on a magnetic recording head and including a solder dam; and

FIG. 7 is another schematic view of exemplary layers on a magnetic recording head and including a solder dam.

### DETAILED DESCRIPTION

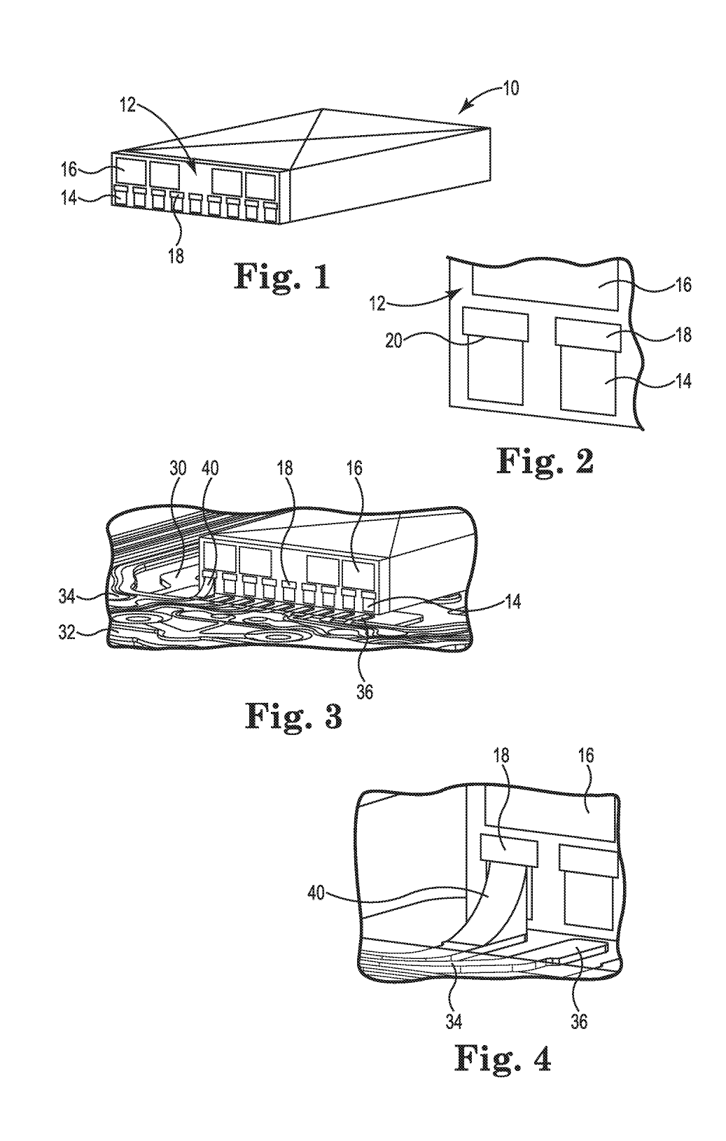

Referring now to the Figures, wherein the components are labeled with like numerals throughout the several Figures, and initially to FIGS. 1 and 2, an exemplary configuration of a head slider 10 of the invention is illustrated. The operative connection between slider 10 and a head suspension assembly typically includes the provision of a gimbal or flexure element (not shown) for permitting the slider to move at least along pitch and roll axes relative to the presentaion of the slider to a spinning disk The gimbal or flexure can be created integrally with the head suspension assembly or as a separate component and attached to the head suspension assembly. In either case, the gimbal or flexure includes a slider bond pad (not shown) to which the slider 10 is attached for controlled movement of the slider 10 as such flies over the media surface of a spinning disk.

Head slider 10 includes a trailing edge 12 having a series of bond pads 14 in a row over a portion of the trailing edge 12. A second series of bond pads 16 is provided in a row adjacent to the bond pads 14, wherein bond pads 16 can be relatively large in comparison to the bond pads 14 of the first row. This illustrates one of any number of orientations of bond pads 14 and 16 relative to one another.

According to the illustrated embodiment, bond pads 14 are provided for electrical connection to the many transducer devices and other devices of a developed slider design, such as including contacts for read and write transducers, read and write heaters bolometers, and/or laser elements as may be provided for operation of a head slider. Certain functional elements of such a slider require positive and negative bond pads 14 for electrical operation, while others require a single bond pad for electrical operation. These bond pads 14 are conventionally electrically connected with wires or conductor elements that are typically provided to extend along the supporting head suspension assembly for controlled operation of each of the functional elements of the head slider 10.

The relatively large second set of bond pads 16 are provided for utilization during the fabrication process of the head slider 10 from a wafer or fabricated substrate, as opposed to the operative use of bonding pads 14 for slider 10 elements during operation of a disk drive. The bond pads 16 are provided to allow for temporary positive and negative electrical connection of electrical lapping guides (ELGs) during slider fabrication processes. As such, pairs of bond pads 16 can be used as ELG pads for ELG monitoring during slider processing. Multiple pairs of bond pads 16 and ELGs are preferably utilized during fabrication.

A slider 10 of the type used in the present invention generally comprises a substrate portion and a multilayer thin film laminate portion, which usually are separated from one another by an insulator layer. The multilayer thin film laminate portion comprises the operative elements that are built within the slider 10 for functionality, as noted above, such as including read and write transducers, heater elements, photonic elements, bolometers, and the like. These elements and the like as have been or are developed for operation within a slider structure are herein referred to as transducer elements. These transducer elements can be formed as thin film structures within the multilayers of the laminate portion. Each of these structures is electrically connected with one or more bond pads to be functional, such as by conductive vias or towers that are formed through the multilayers of the laminate portion, as also known. ELG devices are formed within the multilayer laminate structure and each ELG can be connected to a pair of bonding pads by conductive vias or towers within the structure of the slider 10.

FIGS. 3 and 4 further illustrate a distal end portion of a head stack assembly including head slider 10 positioned relative to a portion of a typical disk drive. Such a disk drive can include at least one magnetic storage disk configured to rotate about an axis, an actuation motor (e.g., a voice coil motor), an actuator arm, a suspension assembly that includes a load beam, and head slider 10 carrying a transducing or read/write head. Slider 10 is supported by a suspension assembly (wherein a suspension tongue 30 of the suspension assembly is visible in FIG. 3) which in turn is supported by actuator arm. Together, actuator arm, suspension assembly and slider 10 form a head stack assembly (HSA). The actuation motor is configured to pivot the actuator arm about an axis in order to sweep the suspension and attached slider 10 in an arc across a surface of rotating disk with slider 10 “sliding” or “flying” across the disk on a cushion of air, often referred to as an air bearing. The read/write head carried by slider 10 can be positioned relative to selected concentric data tracks of the disk by a piezoelectric microactuator, for example. A stack of co-rotating disks can be provided, with additional actuator arms, suspension assemblies, and sliders 10 carrying read/write heads for reading and writing at top and bottom surfaces of each disk in the stack, as desired for a particular configuration.

Slider 10 is securely attached to the suspension tongue 30 using adhesive, solder, or the like. The suspension tongue 30 is connected at one end to a flexure 32, wherein the area where these components intersect provides for spring-like behavior which allows the slider 10 to maintain a certain fly height relative to the disks it will be accessing. The flexure 32 further includes a plurality of electrical traces 34 formed on its upper surface (i.e., the surface that faces toward the slider 10). One end of each of the electrical traces 34 is electrically connected to one of a plurality of electrical pads 36 that are mounted on the suspension tongue 30. The opposite end of the electrical traces 34 are electrically connected to a preamplifier, for example (not shown).

As shown, each of the electrical pads 36 of the flexure 32 is positioned adjacent to a corresponding bond pad 14 of the head 10. In order to electrically connect the electrical pads 36 (and their corresponding electrical traces 34) to the bond pads 14 of the slider 10, a solder joint 40 is provided for each pair of a bond pad 14 and electrical pad 36. Although only one of such solder joints 40 is illustrated in this figure, it is understood that each of the pairs of pads 14, 36 can include a solder joint 40 that provides an electrical connection between components.

In accordance with the invention, each of the bond pads 14 further includes a solder dam 18 at its top portion, the solder dam 18 having a bottom edge 20 that is positioned and sized to be a non-wettable solder dam or stop mask area that is electrically conductive to provide an area for probing. Solder dam 18 is provided to prevent the solder joint 40 from spreading or extending upwardly beyond the bottom edge 20 of the solder dam 18 toward the bond pads 16, as is illustrated in FIGS. 3 and 4, for example. Solder dams of the invention can be configured so that similar wetting areas are provided on perpendicularly arranged surfaces that restrict the expansion of the solder material within certain parameters, thereby providing symmetric solder joints. Thus, when a solder ball or another solder configuration is applied to the bond area, the solder dam will keep the solder material from expanding too far toward the ELG bond pads or other features on the trailing edge of the slider.

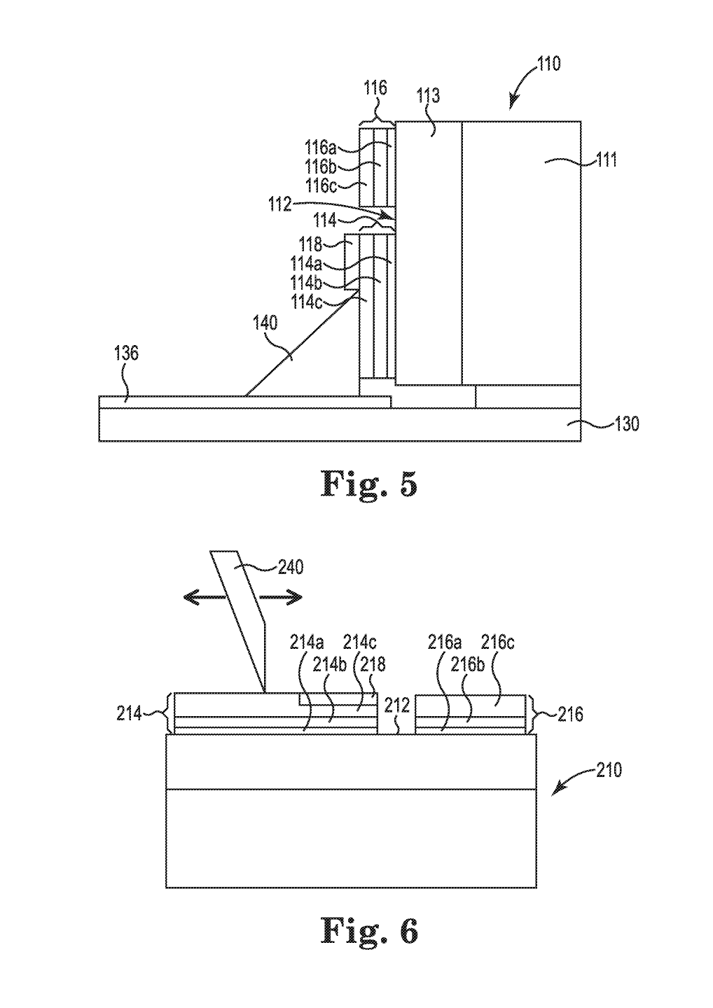

One configuration of layers for providing a solder dam 118 of the invention on a slider 110 is schematically illustrated in FIG. 5. As shown, slider 110 may be constructed of one or more layers of material, such as an aluminium-titanium carbon (AlTiC) alloy base portion 111 with a top alumina layer 113. Slider 110 includes a trailing edge 112 that is generally perpendicular to a suspension member 130 to which it is mounted. Suspension member 130 includes a suspension layer or pad 136, which may be made of gold, for example. Trailing edge 112 includes bond pads 114 and bond pads 116 (which may be an ELG, as discussed above), both of which have multi-layered constructions, wherein more or less layers than shown are contemplated by the invention. In this exemplary embodiment, however, the bond pads 114, 116 have the same three layers, including layers 114a, 116a that may be a chromium layer, layers 114b, 116b that may be a nickel layer, and layers 114c, 116c that may be a gold layer. Solder dam 118 is applied on top of layer 114c of the bond pad 114 so that it extends above the outer surface of the layer 114c. These materials and the illustrated thicknesses of the various layers are only exemplary, and it is understood that many variations of materials and layer thicknesses can be used in accordance with the invention.

Solder dam 118 is a non-wettable material such that when solder is applied to the area between the suspension pad 136 and the bond pad 114, a solder joint 140 is formed that will be “blocked” from extending into the area of the solder dam 118, both by the material from which the dam is made and the physical obstruction of the solder dam 118 that may not be flush with the top surface of the bond pad 114. The solder dam 118 may be made of a material such as rhodium, osmium, titanium, tantalum, aluminum, nickel, diamond-like carbon, stainless steel, and alloys of one or more materials of the group.

Another configuration of layers for providing a solder dam 218 of the invention on a slider 210 is schematically illustrated in FIG. 6. As shown, slider 210 includes a trailing edge 212 that includes bond pads 214 and bond pads 216, both of which have multi-layered constructions. In this exemplary embodiment, the bond pads 214, 216 have the same three layers, including layers 214a, 216a which may be a chromium layer, layers 214b, 216b, which may be a nickel layer, and layers 214c, 216c, which may be a gold layer. As shown, layer 214c of bond pad 214 has a portion that is thicker at one end such that a solder dam layer 218 is provided on the other portion of bond pad 214 to be flush with the top of layer 214c. In order to have the top surfaces of the bond pads 214 and bond pads 216 at the same level, the third layer 216c of bond pad 216 can have an increased thickness, as illustrated. Solder dam 218 is a non-wettable material such that when solder is applied to the bond pad 214, a solder joint is formed that will be “blocked” from extending into the area of the solder dam 218 by the material from which the solder dam 218 is made. With the flush top surface of the bond pad 214, a probe tip 240 can be moved across the top surface of bond pad 214 without having to adjust its level to avoid contact with a raised solder dam.

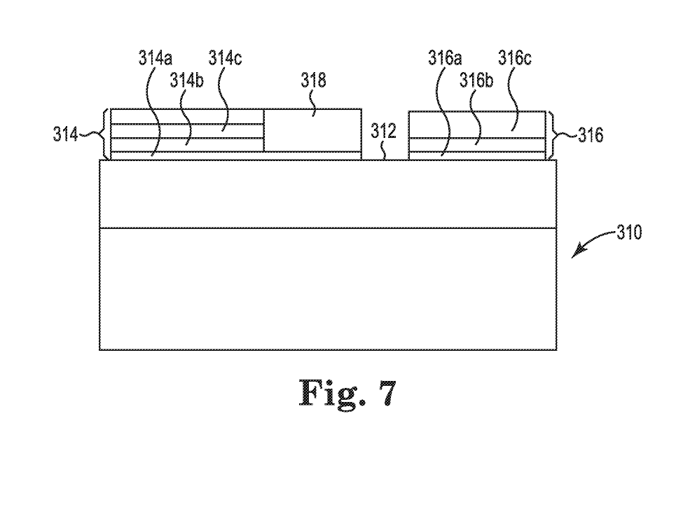

Yet another configuration of layers for providing a solder dam 318 of the invention on a slider 310 is schematically illustrated in FIG. 7. As shown, slider 310 includes a trailing edge 312 that includes bond pads 314 and bond pads 316, both of which have multi-layered constructions. In this exemplary embodiment, the bond pads 314, 316 have three layers, including layers 314a, 316a which may be a chromium layer, layers 314b, 316b, which may be a nickel layer, and layers 314c, 316c, which may be a gold layer, respectively. As shown, layer 314a extends across the entire width of bond pad 314, while layers 314b and 314c of bond pad 314 only extend across a portion of the width of bond pad 314. Solder dam layer 318 is provided on the other portion of bond pad 314 so that it is flush with the top of layer 314c. In order to have the top surfaces of the bond pads 314 and bond pads 316 at the same level, the third layer 316c of bond pad 316 can have an increased thickness, as illustrated. Solder dam 318 is a non-wettable material such that when solder is applied to the bond pad 314, a solder joint is formed that will be “blocked” from extending into the area of the solder dam 318 by the material from which the solder dam 318 is made.

The solder dams provided herein can have a wide variety of configurations, including their height, width, and thickness, in order to limit the expansion of solder to make the solder joint. For example, the solder dam can comprise a small or large portion of the top surface of the bond pad to which it is applied. Due to the coating processes used to apply the solder dam layer to the bond pad, each solder dam will generally have a width that is the same as that of the lower layers of the bond pad, however, it is contemplated that the solder dam is at least slightly wider than the bond pad to which it is adjacently positioned.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

1. A magnetic recording head comprising:
a body comprising a trailing surface;
a plurality of bond pads in a row, each of which is spaced by a gap from an adjacent bond pad along a width of the trailing surface, wherein each bond pad comprises:
two side edges spaced from each other across a width of the bond pad, wherein a width of the gap between adjacent bond pads is defined by one side edge of each of two adjacent bond pads; and
a top edge extending between the two side edges; and
at least one solder dam comprising a nonwettable, electrically conductive material positioned adjacent to the top edge of at least one of the bond pads.

2. The magnetic recording head of claim 1, wherein the at least one solder dam comprises a plurality of solder dams, and wherein each of the solder dams is positioned adjacent to the top edge of one of the plurality of bond pads.

3. The magnetic recording head of claim 1, wherein each solder dam comprises a width that is at least as large as the width of the bond pad to which it is adjacently positioned.

4. The magnetic recording head of claim 1, wherein the at least one solder dam comprises a material selected from a group including rhodium, osmium, titanium, tantalum, aluminum, nickel, diamond-like carbon, stainless steel, and alloys of one or more materials of the group.

5. The magnetic recording head of claim 1, wherein at least one of the solder dams extends above a top surface of the bond pad to which it is adjacent.

6. The magnetic recording head of claim 1, wherein at least one of the solder dams comprises a top surface that that is in the same plane as the top surface of the bond pad to which it is adjacent.

7. The magnetic recording head of claim 1, wherein at least one bond pad comprises a top surface and a thickness defined by the thicknesses of multiple bond pad material layers.

8. The magnetic recording head of claim 7, wherein at least one of the solder dams comprises a top surface that is spaced from the top surface of the bond pad.

9. The magnetic recording head of claim 7, wherein the at least one bond pad comprises a recessed portion in which the at least one solder dam is positioned.

10. A head gimbal assembly, comprising:
a suspension comprising multiple electrical pads; and
a magnetic recording head comprising:
a body comprising a trailing surface;
a plurality of bond pads in a row on the trailing surface, each of which is spaced by a gap from an adjacent bond pad along a width of the trailing surface, wherein each bond pad comprises:
two side edges spaced from each other across a width of the bond pad, wherein a width of the gap between adjacent bond pads is defined by one of the side edges of each of two adjacent bond pads; and
a top edge extending between the two side edges;
at least one solder dam comprising nonwettable, electrically conductive solder material and positioned adjacent to the top edge of one of the bond pads; and
at least one solder joint having a top edge adjacent to the at least one solder dam, wherein each solder joint electrically connects one of the bond pads to one of the electrical pads of the suspension.

11. The head gimbal assembly of claim 10, wherein each solder dam comprises a width that is at least as large as a width of the top edge of the solder joint.

12. The head gimbal assembly of claim 10, wherein each solder dam comprises a width that is at least as large as the width of the bond pad to which it is adjacently positioned.

13. The head gimbal assembly of claim 10, wherein the at least one solder dam comprises a material selected from a group including rhodium, osmium, titanium, tantalum, aluminum, nickel, diamond-like carbon, and alloys of one or more materials of the group.

14. The head gimbal assembly of claim 10, wherein the at least one solder dam comprises a material selected from a group including rhodium, osmium, titanium, tantalum, aluminum, nickel, diamond-like carbon, stainless steel, and alloys of one or more materials of the group.

15. The magnetic recording head of claim 10, wherein at least one of the solder dams extends above a top surface of the bond pad to which it is adjacent.

16. A method of controlling a shape and size of at least one solder joint in a head gimbal assembly using a solder dam adjacent to a bond pad to limit the wetting height, comprising the steps of:
positioning a suspension comprising multiple electrical pads adjacent to a magnetic recording head, the magnetic recording head comprising:
a trailing surface;
a plurality of bond pads in a row on the trailing surface, each of which is spaced by a gap from an adjacent bond pad along a width of the trailing surface, wherein each bond pad comprises:
two side edges spaced from each other across a width of the bond pad, wherein a width of the gap between adjacent bond pads is defined by one of the side edges of each of two adjacent bond pads; and
a top edge extending between the two side edges; and
at least one solder dam comprising nonwettable, electrically conductive solder material and positioned adjacent to the top edge of one of the bond pads;
and
electrically connecting one of the plurality of bond pads of the recording head to one of the multiple electrical pads of the suspension by forming a solder joint having a top edge adjacent to the at least one solder dam.

17. The method of claim 16, wherein the at least one solder dam comprises a plurality of solder dams, each of which is positioned adjacent to the top edge of one of the plurality of bond pads, and wherein the step of electrically connecting bond pads comprises electrically connecting multiple bond pads to multiple respective electrical pads of the suspension.

18. The method of claim 16, wherein each solder dam comprises a width that is at least as large as the width of the bond pad to which it is adjacently positioned.
